(19) United States
(12) Patent Application Publication
(10) Pub. No.: US 2015/0085966 A1
(43) Pub. Date: Mar. 26, 2015

(54) METHOD OF REFORMING METAL SURFACE OF COOLING OR CIRCULATING SYSTEM OF NUCLEAR OR THERMAL POWER PLANT

(71) Applicant: SOONCHUNHYANG UNIVERSITY INDUSTRY ACADEMY COOPERATION FOUNDATION, Asan-si (KR)

(72) Inventors: In Hyoung RHEE, Seoul (KR); Hyun Jun Jung, Suwon-si (KR)

(73) Assignee: SOONCHUNHYANG UNIVERSITY INDUSTRY ACADEMY COOPERATION FOUNDATION, Asan-si (KR)

(21) Appl. No.: 14/051,427

(22) Filed: Oct. 10, 2013

(30) Foreign Application Priority Data
Sep. 23, 2013 (KR) 10-2013-0112518

(51) Int. Cl. G21C 17/022

(52) U.S. Cl. CPC G21C 17/0225
USPC 376/306

(57) ABSTRACT

A method of reforming a metal surface of a cooling or circulating system of a nuclear or thermal power plant is provided. The method of reforming a metal surface of a cooling or circulating system of a nuclear or thermal power plant includes injecting metal ions or metal nanoparticles into a cooling or circulating system of a nuclear or thermal power plant (S11), converting the injected metal ions into metal particles by a chemical reaction with hydrogen (H₂), hydrazine (N₂H₄), or amine in water (S12), and forming an insulating layer or a catalyst layer by depositing metal particles or metal nanoparticles on a metal surface or an oxide coating film of the cooling or circulating system (S13).

### CROSS-REFERENCE TO RELATED APPLICATION

This application claims priority to and the benefit of Korean Patent Application No. 10-2013-0112518, filed on Sep. 23, 2013, the disclosure of which is incorporated herein by reference in its entirety.

### BACKGROUND

1. Field of the Invention

The present invention relates to a method of reforming a metal surface of a cooling or circulating system of a nuclear or thermal power plant, and particularly, to a method of reforming a metal surface of a cooling or circulating system of a nuclear or thermal power plant, which includes forming an insulating layer or a catalyst layer by converting metal ions or metal nanoparticles injected into a system into metal particles by a chemical reaction with hydrogen (H₂), hydrazine (N₂H₄), or amine in water, and depositing metal particles or metal nanoparticles on a metal surface or an oxide coating film of a cooling or circulating system.

2. Discussion of Related Art

In a constitutional components and pipes forming a cooling or circulating system of a nuclear or thermal power plant, corrosion and erosion occur due to water chemical and hydraulic factors. To inhibit the corrosion and erosion, in case of a cooling system, water chemical factors such as a pH of cooling water, an electrochemical potential (ECP), a hydrogen concentration, etc. are controlled, and in case of a circulating system, water chemical factors such as pH, ECP, etc. are controlled using amine or hydrazine.

Despite the control and optimization of the water chemical factors, the corrosion and erosion phenomena of the constitutional components and pipes of the system continuously occur. Accordingly, to overcome the limit of a conventional water chemical control technique, in a pressurized water reactor nuclear power plant, a Zn injection technique is applied to a cooling system to enhance stability of an oxide coating film of a metal material so as to reduce a radiation dose and a corrosion rate. In addition, in a boiling water reactor nuclear power plant, to enhance stability of system constitutional components and a pipe oxide coating film, and to reduce a radiation dose, an online noblechem™ (OLNC) technique of injecting a low-concentration platinum (Pt) compound into the system is applied.

However, the Zn injection technique can be applied only to a pressurized water nuclear reactor coolant system, and generates radioactive substances due to an organic element included in a Zn compound.

In addition, the ONLC technique is impossible to be applied since it does not match operating conditions of a cooling and circulating system of a pressurized water reactor nuclear or thermal power plant.

### SUMMARY OF THE INVENTION

The present invention is directed to a method of reforming a metal surface of a cooling or circulating system of a nuclear or thermal power plant using a metal reformer satisfying operating conditions of a cooling or circulating system of a nuclear or thermal power plant to inhibit corrosion and erosion of a metal material.

According to an aspect of the present invention, there is provided a method of reforming a metal surface of a cooling or circulating system of a nuclear or thermal power plant, which includes: injecting metal ions or metal nanoparticles into a cooling or circulating system of a nuclear or thermal power plant (S11); converting the injected metal ions into metal particles by a chemical reaction with hydrogen (H₂), hydrazine (N₂H₄), or amine in water (S12); and forming an insulating layer or a catalyst layer by depositing metal particles or metal nanoparticles on a metal surface or an oxide coating film of the cooling or circulating system (S13).

The metal ions or metal nanoparticles may include at least one selected from the group consisting of Ti, V, Cr, Ni, Zn, Y, Zr, Ru, Rh, Pd, Ag, In, Sn, Hf, Ta, W, Os, Ir, Pt, and Au.

A system injection concentration of the metal ions or metal nanoparticles may be 10 ppm or less.

A concentration of hydrogen (H₂), hydrazine (N₂H₄), or amine contained in water of the cooling or circulating system of the nuclear or thermal power plant may be 1.2 times or more based on normality (eq/L) of the metal ions.

The amine may be an organic compound including an alcohol group, and serve as a ligand or a reducing agent in a chemical reaction.

In the operation S12, for the reaction occurring in the cooling or circulating system of the nuclear or thermal power plant, a temperature may range from room temperature to 350° C., a pressure may range from an atmospheric pressure to 3,000 psi, and pH may be set to 5 or more.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a flowchart illustrating a method of reforming a metal surface of a cooling and circulating system of a pressurized water reactor nuclear power plant according to the present invention.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

Hereinafter, a method of reforming a metal surface of a cooling or circulating system of a nuclear or thermal power plant according to the present invention will be described in detail with reference to the following drawings.

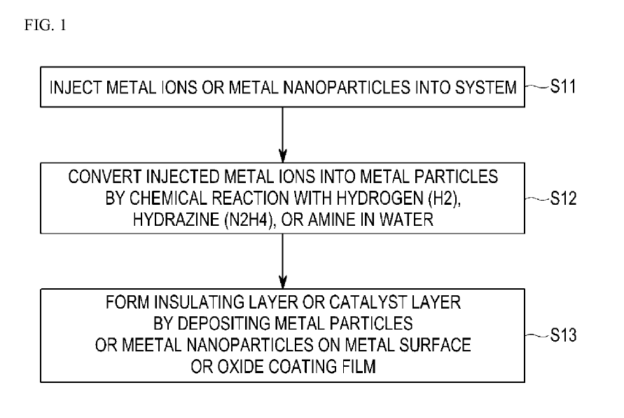

As shown in FIG. 1, the method of reforming a metal surface of a cooling or circulating system of a nuclear or thermal power plant according to the present invention includes injecting metal ions or metal nanoparticles into a cooling or circulating system of a nuclear or thermal power plant (S11); converting the injected metal ions into metal particles by a chemical reaction with hydrogen (H₂), hydrazine (N₂H₄), or amine in water (S12); and forming an insulating layer or a catalyst layer by depositing metal particles or metal nanoparticles on a metal surface or an oxide coating film of the cooling or circulating system (S13).

The metal ions or metal nanoparticles may include at least one selected from the group consisting of Ti, V, Cr, Ni, Zn, Y, Zr, Ru, Rh, Pd, Ag, In, Sn, Hf, Ta, W, Os, Ir, Pt, and Au.

In addition, when the metal ions are complex ions, as a ligand, aqua or hydroxide may be used in a cooling system, and aqua, hydroxide, or amine may be used in a circulating system. In addition, the metal nanoparticles may be metals or oxides thereof.

In the cooling or circulating system of a nuclear or thermal power plant, a concentration of impurities is controlled to ppb or less. Particularly, a concentration of Na⁺, Cl⁻ ions and an organic acid inducing corrosion and erosion of a metal material is thoroughly controlled.

A system injection concentration of the metal ions or metal nanoparticles may be set to 10 ppm or less.

In addition, cooling or circulating system injection concentration and amount may be determined in consideration of power capacity, a material of the system, operating conditions, and operation characteristics.

The nuclear and thermal power plants have different power capacities, system constitutional materials, operating conditions, operation characteristics, and operation history. Accordingly, it is more preferable that the system injection concentration of the metal ions or metal nanoparticles be determined in consideration of all the above-described conditions.

A concentration of hydrogen (H₂), hydrazine (N₂H₄), or amine in water may be 1.2 times or more based on normality (eq/L) of the metal ions.

In addition, the amine may be organic compound including an alcohol group, and serve as a reducing agent.

The metal ions injected into the cooling or circulating system of a nuclear or thermal power plant are reduced into particles by oxidation and reduction to deposit. Accordingly, the hydrogen (H₂), hydrazine (N₂H₄), or amine in the system should serve as a reducing agent. In addition, the oxidation-reduction is a reaction in which electrons are simultaneously donated and received, and thus a concentration of oxidative or reductive chemical species should be calculated in normality, and a concentration of the reducing agent is preferably 1.2 times or more for smooth reduction. For example, Zn ions injected into the cooling system are reduced into Zn particles by oxidation-reduction with hydrogen.

$${H}_{2} \to 2 {H}^{+} + 2 {e}^{-}$$

$$\frac{{Zn}^{2 +} + 2 {e}^{-} \to {Zn}^{0}}{{H}_{2} + {Zn}^{2 +} \to {Zn}^{0} + 2 {H}^{+}}$$

In addition, Pt complex ions injected into the circulating system are converted into Pt particles by oxidation-reduction with hydrazine (N₂H₄).

$${N}_{2} {H}_{4} \to {N}_{2} + 2 {H}_{2} + 4 {e}^{-}$$

$$\frac{{Pt ( OH )}_{4}^{2 -} + 4 {e}^{-} + 4 {H}^{+} \to {Pt}^{0} + 4 {H}_{2} O}{{Pt ( OH )}_{4}^{2 -} + {N}_{2} {H}_{4} \to {Pt}^{0} + {N}_{2} + 4 {H}_{2} O}$$

The metal particles or metal nanoparticles may be deposited on a metal surface or an oxide coating film by physicochemical effects such as a concentration, temperature, pressure, pH, constant voltage, etc. Here, a temperature may range from room temperature to 350° C. or less, a pressure may range from an atmospheric pressure to 3,000 psi, and pH (25) may be 5 or more. In addition, as the temperature increases, a size of the reduced metal particles is decreased, and thus a high temperature of 100° C. or more is more preferable.

An insulating layer or a catalyst layer formed by depositing the metal particles or metal nanoparticles on a metal surface or an oxide coating film interrupts electron transfer, forms a reducing atmosphere, and inhibits corrosion and erosion.

In a cooling or water feeding system of a nuclear or thermal power plant, due to water chemical factors and hydraulic factors, stress corrosion cracking (SCC) occurs in an alloy steel or stainless steel (SS) material, and flow accelerated corrosion (FAC) occurs in a carbon steel (CS) material. Such corrosion and erosion of the metal material may be inhibited by interrupting electron transfer and forming a reducing atmosphere. Accordingly, when the insulating layer or a catalyst layer is formed on a metal surface or an oxide coating film using metal ions or metal nanoparticles, the corrosion and erosion of a metal is inhibited by interrupting electron transfer and forming a reducing atmosphere.

A circulating system of the nuclear power plant is divided into liquid, vapor, and wet steam regions according to physical states of water. In case of the liquid region, using a condensate or feed water drug injection line, injection of the metal ions or metal nanoparticles is possible, but in case of the vapor and wet steam regions, such injection is impossible. Accordingly, in the vapor and wet steam regions, using a pressurized injection device, the metal ions or metal nanoparticles may be injected, or in combination with a drug during a maintenance period.

In addition, since a cooling system is entirely a liquid region, metal ions or metal nanoparticles may be injected through a chemically-controlled system.

According to the present invention, corrosion and erosion of a metal material can be inhibited by reforming a metal surface or an oxide coating film using metal ions or metal nanoparticles satisfying operating conditions of a cooling or circulating system of a nuclear or thermal power plant.

In addition, the method of reforming a metal surface using metal ions or metal nanoparticles can be applied in various industries.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

1. A method of reforming a metal surface of a cooling or circulating system of a nuclear or thermal power plant, comprising:
injecting metal ions or metal nanoparticles into a cooling or circulating system of a nuclear or thermal power plant (S11);
converting the injected metal ions into metal particles by a chemical reaction with hydrogen (H₂), hydrazine (N₂H₄), or amine in water (S12); and
forming an insulating layer or a catalyst layer by depositing metal particles or metal nanoparticles on a metal surface or an oxide coating film of the cooling or circulating system (S13).

2. The method according to claim 1, wherein the metal ions or metal nanoparticles include at least one selected from the group consisting of Ti, V, Cr, Ni, Zn, Y, Zr, Ru, Rh, Pd, Ag, In, Sn, Hf, Ta, W, Os, Ir, Pt, and Au.

3. The method according to claim 1, wherein a system injection concentration of the metal ions or metal nanoparticles is 10 ppm or less.

4. The method according to claim 1, wherein a concentration of the hydrogen (H₂), hydrazine (N₂H₄), or amine contained in water of the cooling or circulating system of the nuclear or thermal power plant is 1.2 times or more based on normality (eq/L) of the metal ions.

5. The method according to claim 1, wherein the amine is an organic compound including an alcohol group, and serves as a ligand or a reducing agent in a chemical reaction.

6. The method according to claim 1, wherein, in the operation (S12), for the reaction in the cooling or circulating system of the nuclear or thermal power plant, a temperature ranges from room temperature to 350° C. or less, a pressure ranges from an atmospheric pressure to 3,000 psi, and pH is 5 or more.

7. The method according to claim 2, wherein, in the operation (S12), for the reaction in the cooling or circulating system of the nuclear or thermal power plant, a temperature ranges from room temperature to 350° C. or less, a pressure ranges from an atmospheric pressure to 3,000 psi, and pH is 5 or more.

8. The method according to claim 3, wherein, in the operation (S12), for the reaction in the cooling or circulating system of the nuclear or thermal power plant, a temperature ranges from room temperature to 350° C. or less, a pressure ranges from an atmospheric pressure to 3,000 psi, and pH is 5 or more.

9. The method according to claim 4, wherein, in the operation (S12), for the reaction in the cooling or circulating system of the nuclear or thermal power plant, a temperature ranges from room temperature to 350° C. or less, a pressure ranges from an atmospheric pressure to 3,000 psi, and pH is 5 or more.

10. The method according to claim 5, wherein, in the operation (S12), for the reaction in the cooling or circulating system of the nuclear or thermal power plant, a temperature ranges from room temperature to 350° C. or less, a pressure ranges from an atmospheric pressure to 3,000 psi, and pH is 5 or more.
